(19) United States
(12) Patent Application Publication
(10) Pub. No.: US 2023/0353508 A1
(43) Pub. Date: Nov. 2, 2023

(54) PACKET TRAFFIC MANAGEMENT

(71) Applicant: Intel Corporation, Santa Clara, CA (US)

(72) Inventors: Kapil SOOD, Portland, OR (US); Patrick CONNOR, Beaverton, OR (US); Scott P. DUBAL, Oregon City, OR (US); James R. HEARN, Hillsboro, OR (US); Brendan RYAN, Limerick (IE); Chris MACNAMARA, Limerick (IE); Conor WALSH, Tullamore (IE); David HUNT, Meelick (IE); John J. BROWNE, Limerick (IE); Kevin LAATZ, Caherconlish (IE)

(21) Appl. No.: 18/220,206

(22) Filed: Jul. 10, 2023

(51) Int. Cl. H04L 49/00; H04L 47/625

(52) U.S. Cl. CPC H04L 49/3018; H04L 47/626

(57) ABSTRACT

Examples described herein relate to a system within a package. In some examples, the system includes a communication fabric and circuitry to adjust a packet throughput rate associated with the communication fabric based at least in part on incoming receive rate across multiple input ports and fabric usage. In some examples, the communication fabric is to communicatively couple devices in the package including one or more of: an accelerator, a processor, a memory, or a network interface device.

### BACKGROUND

System on chips (SoCs) are the building blocks of datacenter and Edge computing platforms. SoCs can include general-purpose hardware with compute cores, as well as task specific circuitry such as cryptographic and artificial intelligence (AI) or machine learning (ML) accelerators, data copying technologies, circuitry and systems to provide security domains, network connectivity, and packet processing. For example, accelerators can perform Convolutional Neural Networks (CNNs) to process incoming media streams. CNNs can be characterized by CNN model parameters, weights, and actuation that can exceed 70-90 MB per model. Given the volumes of data, transferring and processing data among the SoC cores, accelerators, input/output (IO), and memory can lead to congestion. Data transferred through an SoC can be unpredictable, varied, and bursty. Accordingly, due to congestion, performing data processing in a manner that meets or exceeds quality of service (QoS) parameters by use of SoCs may not be achieved.

### BRIEF DESCRIPTION OF THE DRAWINGS

FIG. 1 depicts an example operation of a fabric.

FIG. 2 depicts an example system.

FIG. 3 depicts an example system.

FIG. 4 depicts an example operation.

FIG. 5 depicts an example process.

FIG. 6 depicts an example traffic pattern with corresponding core frequency.

FIG. 7 depicts an example operation.

FIG. 8 depicts an example process.

FIG. 9A depicts an example network interface device.

FIG. 9B depicts an example network interface device.

FIG. 10 depicts an example network interface device.

FIG. 11 depicts an example system.

### DETAILED DESCRIPTION

An SoC can utilize a fabric (e.g., mesh or ring as well as cache pipelines, queues, and other circuitry) to transfer data between the cores and various accelerators. The SoC fabric can be designed for an assumed peak allowable throughput of data within the SoC. If the peak throughput is exceeded, the SoC fabric can enter a congestion state, which results in performance degradation of workloads because of potential data drops or delays in data transfer through the fabric. To avoid performance degradation, internal SoC resources can be over-provisioned, which can lead to excessive power consumption and extra silicon area usage, which can increase a cost of building and operating SoCs.

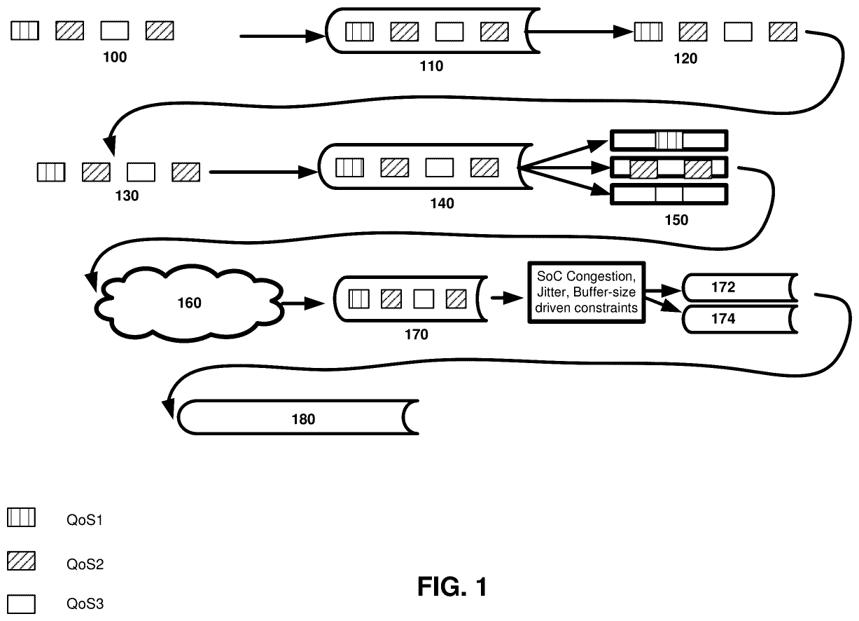

FIG. 1 depicts an example operation of a fabric. At 100, Peripheral Component Interconnect Express (PCIe) Transaction Layer Packets (TLPs) enter the fabric. At 110, an input output (IO) processing stack can fragment one or more of the TLPs into multiple atomic sized packets. PCIe TLPs can have different QoS requirements (e.g., QoS1 to QoS3). At 120, coherence domain atomic-sized packets are output. At 130, coherence domain atomic-sized packets are processed by pipelines. At 140, an IO processing stack associates packets with QoS queues and, at 150, stores the packets into associated QoS queues. At 160, atomic sized packets are transmitted to the fabric for processing by cores, accelerators, etc. However, the fabric may not associate a QoS with any packet and may not prioritize transfer of higher QoS packets through the fabric. At 170, the fabric loses track of QoS for the atomic sized packets. At 172, atomic sized packets can be dropped regardless of QoS level and at 174, atomic sized packets are processed regardless of QoS. At 180, PCIe TLP re-assembly can occur, but where atomic-sized packets are dropped by the fabric, fewer complete PCIe TLPs are fully received. Some TLPs could not be assembled because their ingredient atomic sized packets were dropped by the fabric. This results in poor application performance due to re-transmissions of TLPs.

Lack of ingress traffic scheduling can lead to fabric congestion, dropped packets, and reduced performance of workloads that rely on packets to be successfully received. To attempt to reduce a likelihood of fabric congestion, some examples utilize a timed pacing unit or timed pacing circuitry that can meter or restrict packet ingress rate by scheduling packet ingress, based on packet quality of service, into a fabric or other wired or wireless communications media (e.g., fabric). Timed pacing circuitry can meter or regulate rate of ingress of cache line data blocks or packets into the fabric at particular time intervals and can skip ingress of a packet at an interval based on congestion of the fabric. Timed pacing circuitry can perform ingress (e.g., upstream) packet pacing into the fabric based on fabric queue limits and constraints. Timed pacing circuitry can be used at an ingress IO stack (e.g., PCIe root port and IO processing circuitry) as PCIe packets enter the fabric. Timed pacing circuitry can allow for ingress of packet bursts, without congesting the fabric. The pace of ingress of packets by the timed pacing circuitry can be dynamically modified based on the incoming PCIe rate across multiple PCIe ports and by using telemetry related to fabric internal buffer fullness and fabric mesh utilization. Backpressure can be applied to alter the network interface device to backpressure network traffic ingress rate to the fabric by the timed pacing circuitry as well as potentially apply congestion control to sender of packets to the network interface device.

Accordingly, the fabric can be designed to operate at a lower than assumed maximum peak or worst case level of traffic. Queue sizes can be reduced and die area allocated for buffers can be utilized for other circuitry. Power savings can result from smaller die area for a fabric. A predictable latency for QoS levels may be achieved by use of a pacing circuitry to regulate ingress traffic to a fabric. Various examples of a pacing circuitry can be used in Edge and networking cloud data centers.

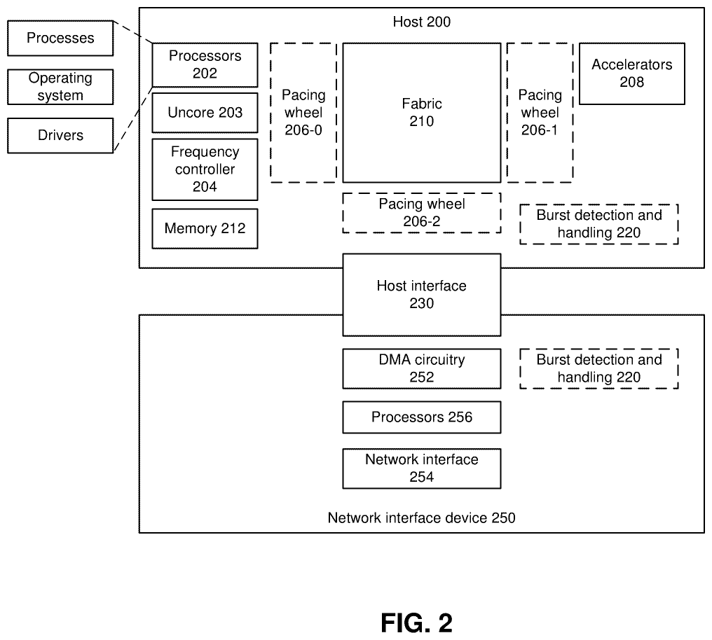

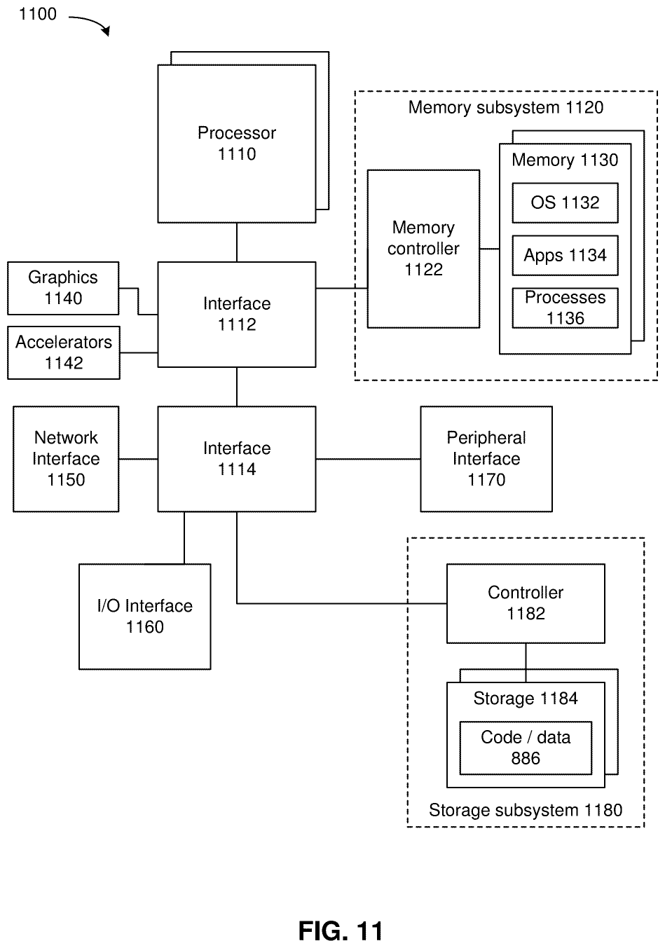

FIG. 2 depicts an example system. Host 200 can be embodied as a server or host system. Various examples of circuitry and software that can be utilized by host 200 are described at least with respect to FIG. 11. Processors 202 can be implemented as one or more processors described herein (e.g., central processing unit (CPU), graphics processing unit (GPU), accelerator, or other circuitry). Processors 202 can execute processes, where processes can include one or more of: application, process, thread, a virtual machine (VM), microVM, container, microservice, or other virtualized execution environment. Various examples of processes can perform packet processing based on one or more of Data Plane Development Kit (DPDK), Storage Performance Development Kit (SPDK), OpenDataPlane, Network Function Virtualization (NFV), software-defined networking (SDN), Evolved Packet Core (EPC), or 5G network slicing. Some example implementations of NFV are described in ETSI specifications or Open Source NFV MANO from ETSI's Open Source Mano (OSM) group. Processes can include virtual network function (VNF), such as a service chain or sequence of virtualized tasks executed on generic configurable hardware such as firewalls, domain name system (DNS), caching or network address translation (NAT) and can run in virtual execution environments. VNFs can be linked together as a service chain. Processes can include a cloud native network function (CNF), which can include a network function that executes inside a container. In some examples, EPC is a 3GPP-specified core architecture at least for Long Term Evolution (LTE) access. 5G network slicing can provide for multiplexing of virtualized and independent logical networks on the same physical network infrastructure. Some processes can perform video processing or media transcoding (e.g., changing the encoding of audio, image, or video files).

System agent or uncore 203 can include or more of a memory controller, a shared cache (e.g., last level cache (LLC)), a cache coherency manager, arithmetic logic units, floating point units, core or processor interconnects, Caching/Home Agent (CHA), interface circuitry (e.g., fabric, memory, device), and/or bus or link controllers. System agent 203 can provide one or more of: direct memory access (DMA) engine connection, non-cached coherent master connection, data cache coherency between cores and arbitrates cache requests, or Advanced Microcontroller Bus Architecture (AMBA) capabilities.

Processors 202 can execute an operating system (OS) and device drivers. For example, OS or processes can issue an application program interface (API) to activate or deactivate features of pacing wheel (e.g., timed pacing circuitry) 206-0, 206-1, or 206-2 or burst detection and handling 220. Example features of pacing wheel 206-0, 206-1, or 206-2 can include controlling or limiting a transmit rate of packets or other data into fabric 210, as described herein. Example features of burst detection and handling 220 can include detecting changes in frequency of core operation and performing actions to attempt to reduce packet processing latency and reduce packet drops, as described herein.

Pacing wheel 206-0 can be positioned to control ingress of packets or data from processors 202 to fabric 210. Pacing wheel 206-1 can be positioned inside accelerators 208 or to control ingress of packets or data from accelerators 208 to fabric 210. Pacing wheel 206-2 can be positioned inside network interface device 250 or to control ingress of packets from network interface device 250 from host interface 230 to fabric 210. Telemetry of fabric 210 can be shared with those devices (e.g., network interface device 250 or accelerators 208), provided those devices are trusted and telemetry is not readable by platform administrators.

In some examples, based on load information of a receiver, pacing wheels 206-0 to 206-2 can perform pacing of egressed packets or data from fabric 210 to the receiver, such as to processors 202, accelerators 208, or network interface device 250 to attempt to reduce likelihood that a packet or data is dropped by the receiver.

In some examples, a Hardware Queue Manager (HQM) (e.g., work scheduler with queues that can load balance processors or allocate data to processors) can be used to pace packet ingress into fabric 210 after processing by accelerators 208 or network interface device 250.

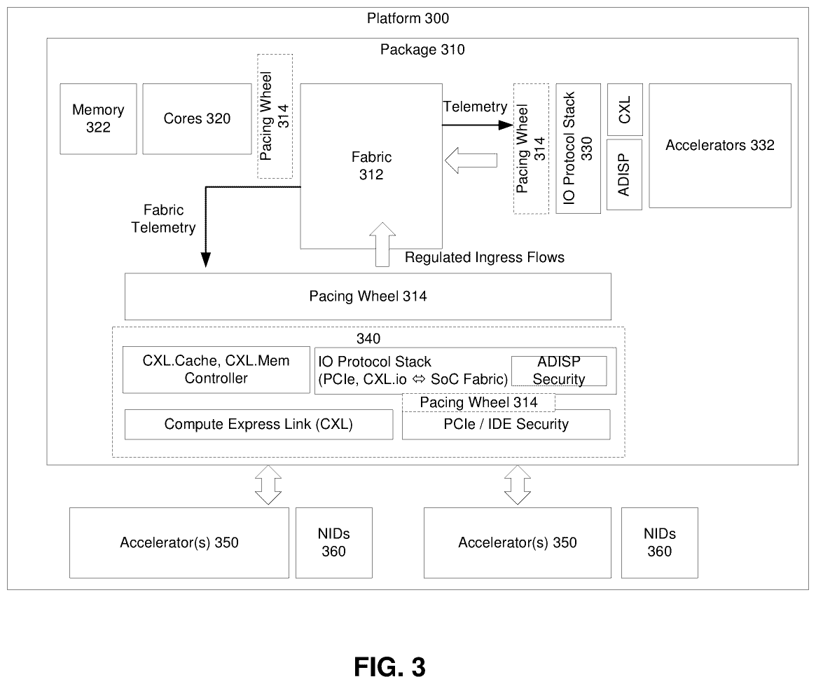

Fabric 210 can be implemented as a mesh or ring and provide inter-die communication, delivering data to or reading data from various caches of different dies, on-SoC accelerators, on-SoC Ethernet network interface device 250, switches, etc. For example, fabric 210 can provide communications among processors 202, accelerators 208, memory 212, and host interface 230. Fabric 210 can include circuitry such as an interconnect, bridge, Caching Agents (CAs), Home Agents (HAs), snoop filter, pipelines, queues, and other circuitry. Fabric 210 can communicate data such as a packet, a PCIe TLP packet when ingressed or egressed from the SOC's IO stack (described with respect to FIG. 3), or a cache line size data when traversing inside fabric 210.

Burst detector and handler 220 can detect patterns that indicate a burst of received packet traffic and automatically trigger processing of such bursts of traffic. Examples of patterns that indicate a burst of received traffic include fluctuations in frequency of operation of a core, accelerator, or network interface device that processes packets received by a network interface device. Examples of triggered processing of such bursts of traffic include one or more of: add more processor capacity to process packets, increase frequency of operation of a core, increase power supplied to a core, disable P state management core that manages network interface in order to allow increased power usage while traffic is bursty, migrate data processing thread to another core with more packet processing capability, and so forth. In some examples, burst detector and handler 220 can select a triggered processing of such bursts of traffic based on permitted latency (e.g., peak or average) of a particular quality of service level of packets to be processed as well as power usage and device temperature requirements for the quality of service or the package. For example, burst detector and handler 220 can select an action to perform to achieve latency and/or power and device temperature requirements for the quality of service or the package.

Frequency controller 204 can be implemented as a driver, circuitry, firmware, or other software. As described herein, frequency controller 204 can be utilized to adjust a frequency or power of operation of a core or disable power management of a core.

Host interface 230 can provide communications between host 200 and network interface device 250. In various examples, host interface 230 can provide communications consistent with Peripheral Component Interconnect Express (PCIe), Compute Express Link (CXL), Universal Chiplet Interconnect Express (UCIe), or other connection technologies. See, for example, Peripheral Component Interconnect Express (PCIe) Base Specification 1.0 (2002), as well as earlier versions, later versions, and variations thereof. See, for example, Compute Express Link (CXL) Specification revision 2.0, version 0.7 (2019), as well as earlier versions, later versions, and variations thereof. See, for example, UCIe 1.0 Specification (2022), as well as earlier versions, later versions, and variations thereof.

In some examples, network interface device 250 can refer to one or more of: a network interface controller (NIC), a remote direct memory access (RDMA)-enabled NIC, SmartNIC, router, switch, forwarding element, infrastructure processing unit (IPU), data processing unit (DPU), or network-attached appliance. While examples are described with respect to network interface devices, examples can apply to storage devices (e.g., non-volatile memory express (NVMe)) or accelerators. For example, power and/or frequency of operation can be monitored for a storage device, accelerator, or network interface device for bursty behavior.

FIG. 3 depicts an example platform. Platform 300 can include a package 310 that can communicate with devices via interfaces 340 (e.g., CXL or PCIe interfaces). Assignable device interface security protocol (ADISP) security (or other encryption) can provide PCIe link security based on Intel® Trust Domain Extensions (TDX) connection to differentiate TDX (encrypted) workloads from non-encrypted workloads. Devices 360 can include accelerators 350 (e.g., cryptographic, compression, decompression, AI/ML, access control list (ACL) or lookup engines, media processors) and network interface devices 360.

Package 310 can enclose fabric 312, cores 320, memory 322, pacing wheels (e.g., timed pacing circuitry) 324, accelerators 332, and interface 340. Cores 320 can execute instructions and include or access various cache devices (e.g., level 1 cache (L1), level 2 cache (L2), level 3 cache (L3), last level cache (LLC)). One or more of cores 320 can issue commands to activate or deactivate operation of a pacing wheel and instead, fabric 312 can receive packets in an unmetered manner.

Memory 322 can include one or more of: one or more registers, one or more cache devices (e.g., L1, L2, L3, LLC), volatile memory device, non-volatile memory device, or persistent memory device. For example, memory 108 can include static random access memory (SRAM) memory technology or memory technology consistent with high bandwidth memory (HBM), or double data rate (DDR), among others. Memory 322 can store data to be transmitted, data received in packets, and other metadata.

IO protocol stack 330 can convert PCIe or CXL packets received from PCIe or CXL interface into cache lines sized data. PCIe or CXL packets can include TLPs or Flow Control Units (flits). IO protocol stack 330 can split PCIe transactions from an incoherent ordered PCIe/CXL domain into SoC coherent domain transactions.

For example, pacing wheel (PW) circuitry 314 can be positioned between IO protocol stack (e.g., PCIe, CXL, etc.) processor 330 and fabric 312. An instance of pacing wheel 314 can be placed in one or more dies or chiplets to be connected to IO stack 330 through an on-package interface (e.g., PCIe/CXL or UCIe). Accelerators 332 and 350 and may be on the same SoC die and pacing wheel circuitry 314 can be positioned at a junction of IO 330 stack and fabric 312. Pacing wheel 314 can regulate ingress of communications from CXL-connected devices (e.g., Type 1, Type 2, and Type 3) to one or more ports of fabric 312. In such scenarios, the CXL.cache and CXL.mem transactions from interface 340 can bypass standard PCIe stack and instead can be processed by CXL controller logic, which can transfer transactions to pacing wheel 314. Other instances of PW circuitry 314 can be positioned to receive communications from interface 340 and cores 320. For example, one or more instances of PW circuitry 314 can provide packets to one or more input ports of fabric 312 and/or receive packets from one or more output ports of fabric 312.

Pacing wheel circuitry 314 can adjust packet processing throughput rate or rate of advancement of packets or other data (e.g., encrypted or unencrypted) into one or more input ports or other ingress circuitry of fabric 312 based at least in part on incoming receive rate at multiple input ports to fabric 312, QoS level of a transaction, and fabric usage (e.g., queue level). Pacing wheel (PW) circuitry 314 can allocate ingress bandwidth to packet transactions to be provided to fabric 312 based on QoS levels. For example, PW circuitry 314 can prioritize higher QoS (priority) packet transactions by providing more bandwidth to higher QoS transactions than provided to lower QoS (lower priority) packet transactions. Pacing wheel 314 can be used to reduce a likelihood that transactions from cores 320, accelerators 332, accelerators 350, and NIDs 360 overload fabric 312 and lead to dropping of packets by fabric 312.

In some examples, where ADISP or other data encryption/decryption is applied, pacing wheel circuitry 314 can consider a frequency and/or power and throughput of a memory encryption circuitry (e.g., not shown) in determining pacing of packets subject to ADISP or other data encryption/decryption into fabric 312. For example, if frequency and/or power and throughput of a memory encryption circuitry is below a first level, the pacing of packets into fabric 312 can be reduced or kept the same. For example, if frequency and/or power and throughput of a memory encryption circuitry is above a second level (higher than the first level), the pacing of packets into fabric 312 can be increased or kept the same.

Fabric 312 can provide telemetry to pacing wheel 314. Telemetry can include internal buffers usage statistics from fabric control points (e.g., Caching Agents, Home Agents, virtualization logic blocks, etc.), internal buffer overflow status, CA utilization, HA utilization, fabric bridge ingress loads, fabric bridge egress loads, pipeline occupancies, fabric saturation, etc. Telemetry collection can depend on a rate of transactions entering a pacing wheel. For instance, during high-utilization windows, the telemetry sampling rate could be on the order of a few microseconds, but could go increase to a lower sampling rate (less frequent) when transactions reduce in rate.

Pacing wheel 314 can adjust an aggregate ingress rate to fabric 312 based on telemetry. For example, based on utilization of fabric 312 being high or above a first level, an interval between releases of packets or transactions into fabric 312 can be increased and pacing wheel 314 can permit ingress of higher QoS transactions more frequently than ingress of lower QoS transactions. For example, ingress time slots can be set at a nanosecond or other time interval. As utilization of fabric 312 achieves a pre-determined upper-end boundary limits (e.g., 80% utilization), then pacing wheel 314 can prioritize ingress of higher priority transactions and/or adjust ingress transactions rate into fabric 312.

In some examples, pacing wheel 314 can be a trusted device that is authenticated and attested by an attestation server or management controller and can access telemetry in a trusted manner after authentication and attestation. Pacing wheel 314 can provide communication among PCIe-connected devices, which may or may not utilize encryption based on Peripheral Component Interconnect Special Interest Group (PCI-SIG) Integrity and Data Encryption (IDE) specification (Dec. 2, 2020).

Pacing wheel 314 can be put into a deep power save state when the ingress transaction rate to fabric 312 is below a certain level because the load on fabric 312 is lower, pacing wheel 314 may not be utilized as a likelihood of packet drops and congestion is relatively low.

Platform 300 can be implemented as part of a system-on-a-chip (SoC) or included on a multichip package. Fabric 312 can provide die-to-die communications; chip-to-chip communications; circuit board-to-circuit board communications; package-to-package communications; and/or server-to-server communications. Die-to-die communications can utilize Embedded Multi-Die Interconnect Bridge (EMIB) or an interposer. Components of FIG. 3 can be enclosed in one or more semiconductor packages. A semiconductor package can include metal, plastic, glass, and/or ceramic casing that encompass and provide communications within or among one or more semiconductor devices or integrated circuits. Various examples can be implemented in a die, in a package, or between multiple packages, in a server, or among multiple servers.

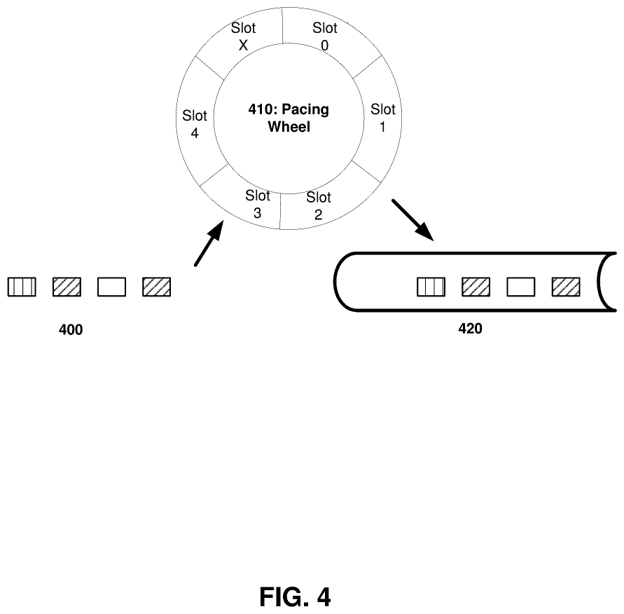

FIG. 4 depicts an example operation of a fabric with utilization of pacing wheel circuitry. At 400, PCIe TLP transactions can ingress into the SoC or CPU through a PCIe Root Port. For example, an 10 processing stack can fragment the TLP into multiple atomic sized packets to output SoC coherence domain atomic-sized packets.

At 410, TLP transactions can be associated with one or more pacing wheel time slots, where the pacing wheel can regulate pace of entry of transactions to a fabric for a particular PCIe Virtual Channel to maintain PCIe TLP transactions processing semantics (e.g., Ordered, Relaxed and Unordered Flows). The pacing wheel can enforce a peak or minimum ingress rate of PCIe transactions to the fabric. In some examples, pacing wheel can allocate packets of higher QoS to more time slots than packets of lower QoS.

Multiple timing wheels could be available to handle one or more application connections or one or more ingress ports to a fabric. For example, one or more pacing wheels can be assigned to control ingress of packets from different Virtual Function Work Queue or PCIe Assignable Device Interfaces. For instance, for DPDK packet processing applications, a queue to IO (e.g., network interface device or accelerator) may utilize a particular pacing wheel that applies QoS and time slot interval adjustment policies for that application or ingress port.

At 420, atomic sized packets can be ingressed to the fabric according at allocated time slots. Upon completion of packet processing, the packets can egress out of the fabric to memory or another device.

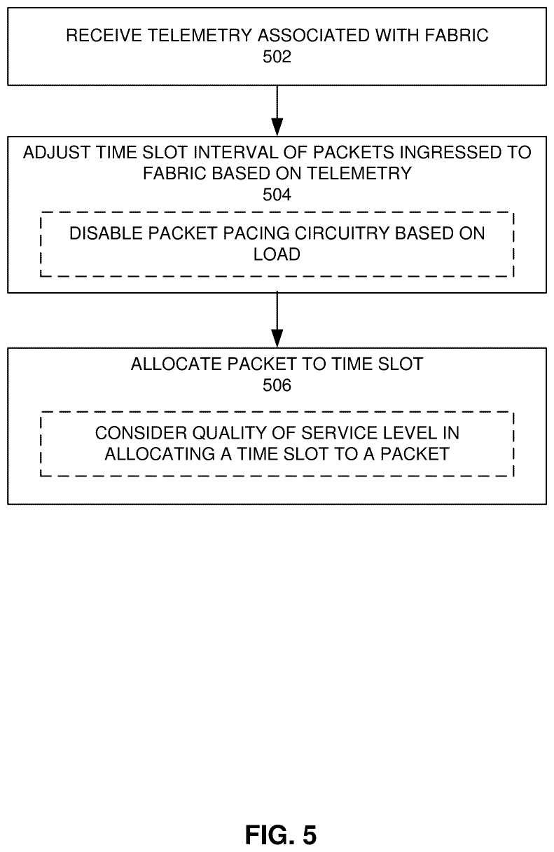

FIG. 5 depicts an example process. The process can be performed by a pacing or timing circuitry. At 502, telemetry data can be received concerning a load on a fabric. For example, the fabric can be within a package and the fabric can provide communications at least among processors, memory, accelerators, and network interface devices. Telemetry data can include a rate of ingress to the fabric and various load information on the fabric (e.g., queue depth), as well as other information. At 504, a time interval between ingress of packets to the fabric can be adjusted based on the telemetry. For example, based on a high load on the fabric, a time interval between slots can be increased to reduce a rate of packet ingress into the fabric. For example, based on a low load on the fabric, a time interval between slots can be decreased to increase a rate of packet ingress into the fabric. In some examples, the pacing circuitry can be powered down based on a load level on the fabric being below a level. Note that time intervals between ingress time slots may not be increased but rather ingress time slots may be skipped to reduce ingress rate. At 506, a packet or other data can be allocated to an ingress time slot. For example, quality of service of the packet or other data can be considered in determining a number of time slots to allocate to the packet or other data.

Network traffic bursts or bursty traffic are a concern for network application software providers. Unexpected traffic bursts (e.g., micro-bursts) may cause data packet drops if the system resources (e.g., processor and/or memory) are not capable of processing or storing the packets. Intermittent traffic bursts disrupt power management solutions based on central processing unit (CPU) core frequency control. Traffic bursts or spikes (e.g., Peak Information Rate (PIR)) can be provisioned and enforced for network interfaces as a quality of service (QoS) parameter on general-purpose network functions virtualization (NFV) or cloud-native platforms. However, packet drops may occur if a system's resource management software cannot react in time.

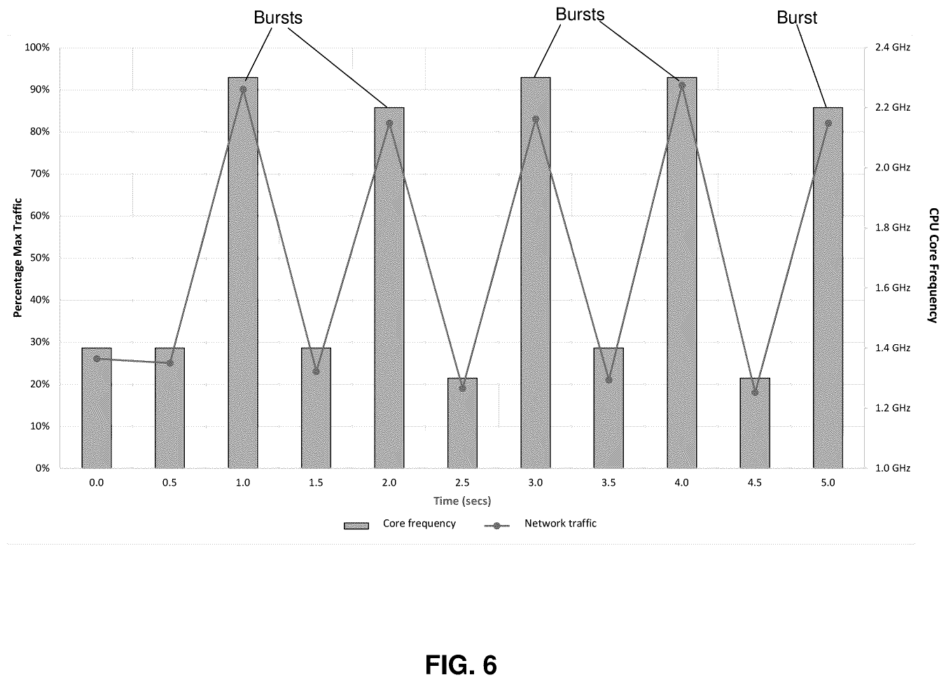

FIG. 6 depicts an example traffic pattern with corresponding CPU core frequency for a network interface device that provides received packets in a bursty manner. A CPU core can be configured with a number of frequency levels, also known as P-states, and may be adjusted dynamically between its maximum and minimum frequency rating. Generally, a single isolated CPU core can execute a poller thread that polls for received data packets from a network interface device. Example frameworks for poller threads include Data Plane Development Kit (DPDK), netmap, PF_RING™ ZC (Zero Copy), or others.

For example, a poller can read a register or memory space to determine if a new input/output (I/O) transaction is available to process. If a new I/O transaction is available to process, the poller can complete a descriptor for the I/O transaction and process new I/O transactions and then inform the I/O submitter (e.g., application) of the completion status of the I/O transaction. A poller can process the I/O transaction by performing protocol handling, buffer management, or interact with the network interface device. Performing protocol handling can include preparing the I/O request from a packet. Buffer management can include preparing a buffer for packet receipt from an Ethernet network interface device. Interact with the storage or network device can include sending I/O request to a network interface device.

CPU core frequency (or P-state) adjustment can control the polling rate and a single CPU core frequency can correlate to a received packet traffic load for a single network interface. When received traffic rate is lower, core frequency can be reduced to reduce power consumption. However, where a burst of packets is received, the polling rate may be too low and packet loss may occur.

At least to attempt to reduce a likelihood of packet loss or insufficiently low polling rate, circuitry, firmware, and/or processor-executed software can monitor changes to frequency of operation of a central processing unit (CPU) core, or processor or accelerator, to detect patterns that indicate a burst of received packet traffic and automatically trigger processing of such bursts of traffic while conserving power usage but not consistently provisioning CPU resources for processing of peak amount of traffic or for worst-case traffic burst patterns (e.g., peak information rate (PIR)). Conserving power usage can reduce customer capital expenditure (CapEx) and operating expenditure (OpEx). In some cases, monitoring of CPU core frequency can be more readily achieved than measuring and monitoring of key performance indicators (KPIs), such as network traffic load variance and can occur independent of executed network application software or manufacturer and model of network interface card (NIC). Accordingly, latency sensitive applications such as network packet-processing solutions (e.g., NFVs or virtual network functions (VNFs)) can potentially benefit from reduced packet drops and reduced latency of packet processing.

Referring again to FIG. 2, burst detection and handling 220 can detect patterns that indicate a burst of received packet traffic and automatically trigger processing of such bursts of traffic. In some examples, burst detection and handling 220 can be implemented as software running on a core, part of an uncore, CPU microcode, firmware, or others.

For example, burst detection and handling 220 can detect a network interface with bursty traffic based on repeated fluctuations in P state in core. Burst detection and handling 220 can monitor CPU core frequencies on a platform for a configured set of CPU cores and track variance between maximum (or high) and minimum (or low) CPU core frequency per a configurable fixed time interval. If a threshold variance is exceeded for a number of consecutive intervals, the associated network interface device can be identified as bursty. In some examples, burst detection and handling 220 can detect the bursty network interface device based on traffic in pacing wheel 206-2 based on telemetry such as queue depth or backlog. Burst detection and handling 220 can utilize pacing wheel telemetry to detect a bursty network interface device. Burst detection and handling 220 can collect information for burst handling such as the level of burstiness (e.g., average of percentage of peak CPU core frequency detected or pacing wheel queue depth of backlog), identifier (ID) of core that is assigned to process the packet, network interface device identifier and process ID(s) of processes that process the packets from the bursty network interface device.

Burst detection and handling 220 can perform operations to manage bursts of traffic, including remedial actions such as one or more of: add more processor capacity to process packets, disable P state management core that manages network interface in order to allow increased power usage while traffic is bursty, migrate data processing thread to another core with more packet processing capability, notify the network interface device to route a percentage (e.g., up to 100%) of received network traffic to a different one or more receive queues, notify a data-plane application to forward a percentage (e.g., up to 100%) of network traffic to a polling thread running on another CPU core, or raise an alarm in relation to the bursty network interface.

Burst detection and handling 220 can continue to monitor the core(s) that executes threads that process traffic from the bursty network interface device, and if the bursty network interface device does not exhibit bursty behavior after a configurable period of time, the network interface device can be identified as no longer bursty and perform actions such as reducing frequency of operation of a core that processes formerly bursty traffic or migrating a thread that processes formerly bursty traffic to another core that is underutilized.

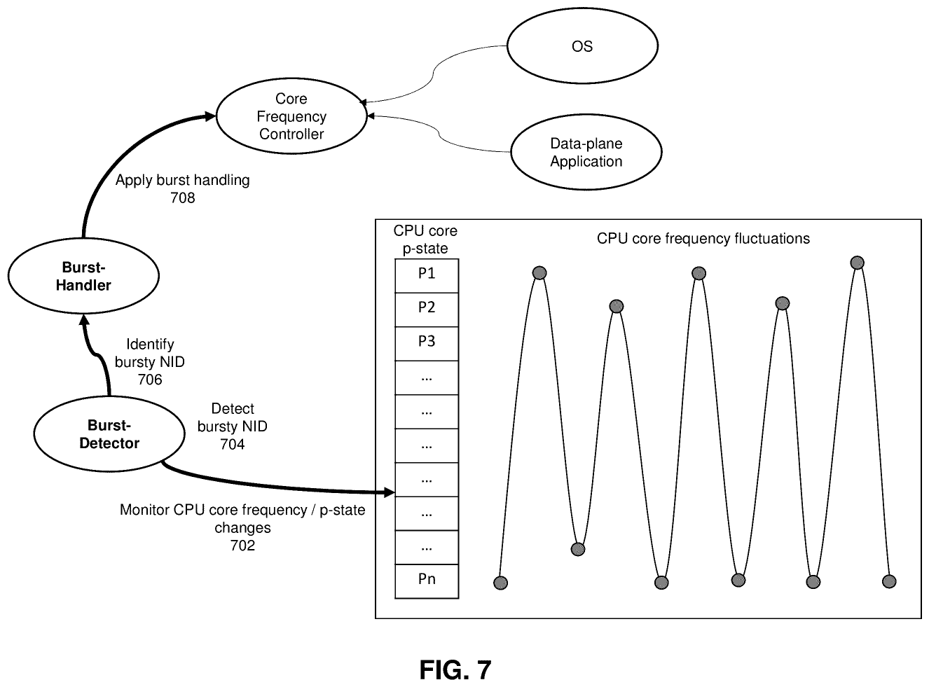

FIG. 7 depicts an example operation. At 702, a burst detector can monitor for bursty traffic from a network interface device or other device based on changes in applied operating clock frequency. At 706, based on detection of changes to operating clock frequency such as from Pn to P1 or P0, where n is an integer value, of two or more times, a bursty network interface device (NID) can be identified. Example values of p-state and number of fluctuations of P-states to trigger identification of a bursty NID are exemplary, and other values can be used. At 708, burst handling can be applied such as migrating processes that process received traffic to another core that operates at a peak or near-peak frequency of operation, raising a frequency of operation of a core that processes the packets from the bursty NID, raising an alarm to indicate bursty behavior to an administrator, or others.

Examples described herein can be used for processing mobile network traffic network in a 5G Core User-Plane Function (UPF). A misconfigured switch in a Radio Access Network (RAN) backhaul to the UPF may produce packet fragmentation or multiplexing of network traffic into a particular network interface and cause a bursty network interface device. Examples described herein can detect a bursty network interface device and perform remedial actions described herein.

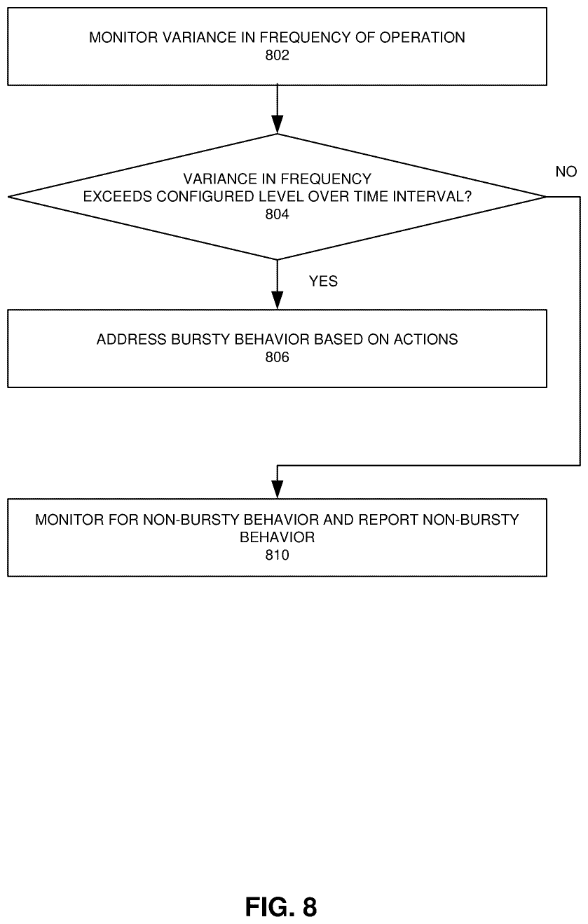

FIG. 8 depicts an example process. At 802, the variance between maximum (e.g., peak) and minimum (e.g., low) CPU core frequencies per configurable fixed time interval can be tracked. At 804, if a threshold variance is exceeded for a number of consecutive intervals, the associated network interface device can be marked as “bursty” and the process can proceed to 806. If threshold variance not met or exceeded, the process can return to 802. At 806, relevant details which may be needed for burst handling such as the level of burstiness, core ID, network interface identifier and process id(s) can be determined. At 806, rules to handle bursts to CPU core frequency controller can be determined. Actions can include: send a notification to NIC logic to route a percentage of network traffic to a different NIC receive (Rx) queue; notify the data-plane application to forward a percentage of network traffic to a polling thread running on another CPU core; move software threads to another CPU core; or raise an alarm in relation to the bursty network interface. At 810, the core which is processing traffic for the bursty network interface can be monitored, and if the network interface device is considered stable after a configurable period of time, it sends another notification to the Burst Handler to indicate that the network interface is no longer bursty.

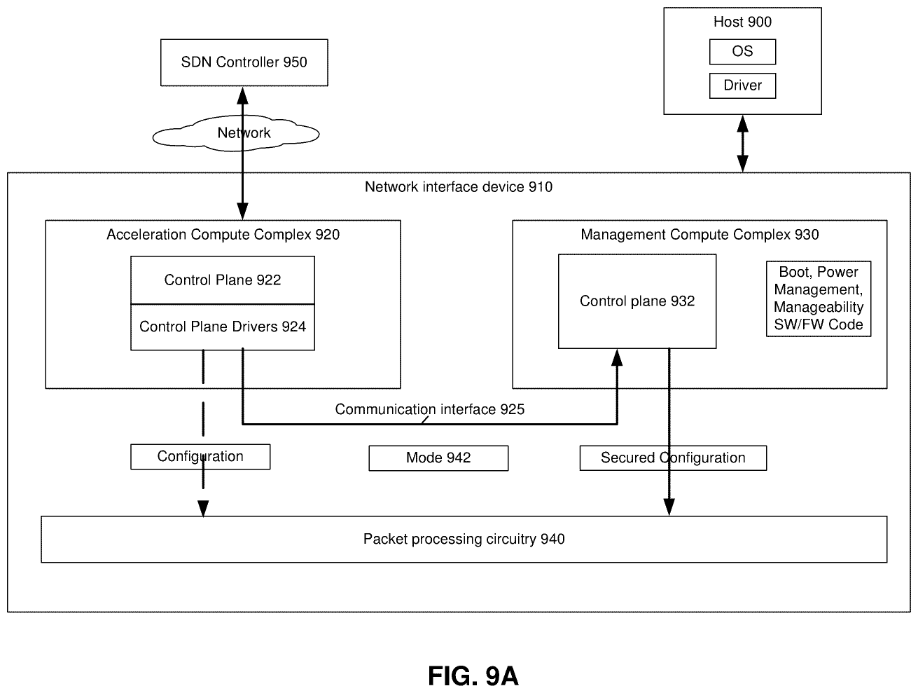

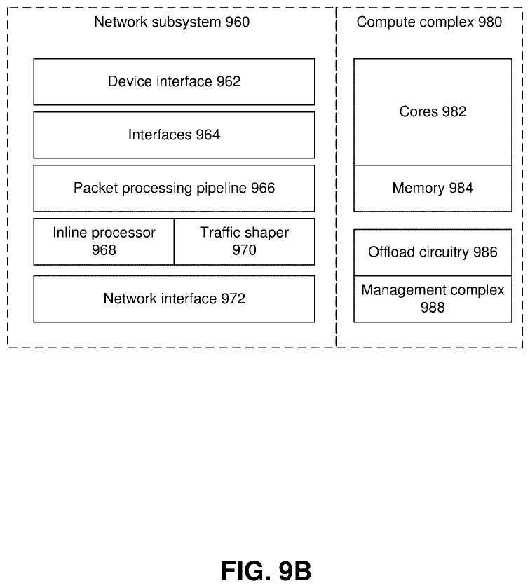

FIG. 9A depicts an example network interface device. Host 900 can include processors, memory devices, device interfaces, as well as other circuitry such as described with respect to FIG. 11. Processors of host 900 can execute software such as applications (e.g., microservices, virtual machine (VMs), microVMs, containers, processes, threads, or other virtualized execution environments), operating system (OS), and device drivers. An OS or device driver can configure network interface device or packet processing device 910 to utilize one or more control planes to communicate with software defined networking (SDN) controller 950 via a network to configure operation of the one or more control planes.

Packet processing device 910 can include multiple compute complexes, such as an Acceleration Compute Complex (ACC) 920 and Management Compute Complex (MCC) 930, as well as packet processing circuitry 940 and network interface technologies for communication with other devices via a network. ACC 920 can be implemented as one or more of: a microprocessor, processor, accelerator, field programmable gate array (FPGA), application specific integrated circuit (ASIC) or circuitry described at least with respect to FIG. 11. Similarly, MCC 930 can be implemented as one or more of: a microprocessor, processor, accelerator, field programmable gate array (FPGA), application specific integrated circuit (ASIC) or circuitry described at least with respect to FIG. 11. In some examples, ACC 920 and MCC 930 can be implemented as separate cores in a CPU, different cores in different CPUs, different processors in a same integrated circuit, different processors in different integrated circuit.

Packet processing device 910 can be implemented as one or more of: a microprocessor, processor, accelerator, field programmable gate array (FPGA), application specific integrated circuit (ASIC) or circuitry described at least with respect to FIG. 11. Packet processing pipeline circuitry 940 can process packets as directed or configured by one or more control planes executed by multiple compute complexes. In some examples, ACC 920 and MCC 930 can execute respective control planes 922 and 932.

SDN controller 950 can upgrade or reconfigure software executing on ACC 920 (e.g., control plane 922 and/or control plane 932) through contents of packets received through packet processing device 910. In some examples, ACC 920 can execute control plane operating system (OS) (e.g., Linux) and/or a control plane application 922 (e.g., user space or kernel modules) used by SDN controller 950 to configure operation of packet processing pipeline 940. Control plane application 922 can include Generic Flow Tables (GFT), ESXi, NSX, Kubernetes control plane software, application software for managing crypto configurations, Programming Protocol-independent Packet Processors (P4) runtime daemon, target specific daemon, Container Storage Interface (CSI) agents, or remote direct memory access (RDMA) configuration agents.

In some examples, SDN controller 950 can communicate with ACC 920 using a remote procedure call (RPC) such as Google remote procedure call (gRPC) or other service and ACC 920 can convert the request to target specific protocol buffer (protobuf) request to MCC 930. gRPC is a remote procedure call solution based on data packets sent between a client and a server. Although gRPC is an example, other communication schemes can be used such as, but not limited to, Java Remote Method Invocation, Modula-3, RPyC, Distributed Ruby, Erlang, Elixir, Action Message Format, Remote Function Call, Open Network Computing RPC, JSON-RPC, and so forth.

In some examples, SDN controller 950 can provide packet processing rules for performance by ACC 920. For example, ACC 920 can program table rules (e.g., header field match and corresponding action) applied by packet processing pipeline circuitry 940 based on change in policy and changes in VMs, containers, microservices, applications, or other processes. ACC 920 can be configured to provide network policy as flow cache rules into a table to configure operation of packet processing pipeline 940. For example, the ACC-executed control plane application 922 can configure rule tables applied by packet processing pipeline circuitry 940 with rules to define a traffic destination based on packet type and content. ACC 920 can program table rules (e.g., match-action) into memory accessible to packet processing pipeline circuitry 940 based on change in policy and changes in VMs.

A flow can be a sequence of packets being transferred between two endpoints, generally representing a single session using a protocol. Accordingly, a flow can be identified, using a match, by a set of defined tuples and, for routing purpose, a flow is identified by the two tuples that identify the endpoints, e.g., the source and destination addresses. For content-based services (e.g., load balancer, firewall, Intrusion detection system etc.), flows can be identified at a finer granularity by using N-tuples (e.g., source address, destination address, IP protocol, transport layer source port, and destination port). A packet in a flow is expected to have the same set of tuples in the packet header. A packet flow to be controlled can be identified by a combination of tuples (e.g., Ethernet type field, source and/or destination IP address, source and/or destination User Datagram Protocol (UDP) ports, source/destination TCP ports, or any other header field) and a unique source and destination queue pair (QP) number or identifier.

For example, ACC 920 can execute a virtual switch such as vSwitch or Open vSwitch (OVS), Stratum, or Vector Packet Processing (VPP) that provides communications between virtual machines executed by host 900 or with other devices connected to a network. For example, ACC 920 can configure packet processing pipeline circuitry 940 as to which VM is to receive traffic and what kind of traffic a VM can transmit. For example, packet processing pipeline circuitry 940 can execute a virtual switch such as vSwitch or Open vSwitch that provides communications between virtual machines executed by host 900 and packet processing device 910.

MCC 930 can execute a host management control plane, global resource manager, and perform hardware registers configuration. Control plane 932 executed by MCC 930 can perform provisioning and configuration of packet processing circuitry 940. For example, a VM executing on host 900 can utilize packet processing device 910 to receive or transmit packet traffic. MCC 930 can execute boot, power, management, and manageability software (SW) or firmware (FW) code to boot and initialize the packet processing device 910, manage the device power consumption, provide connectivity to Baseboard Management Controller (BMC), and other operations.

One or both control planes of ACC 920 and MCC 930 can define traffic routing table content and network topology applied by packet processing circuitry 940 to select a path of a packet in a network to a next hop or to a destination network-connected device. For example, a VM executing on host 900 can utilize packet processing device 910 to receive or transmit packet traffic.

ACC 920 can execute control plane drivers to communicate with MCC 930. At least to provide a configuration and provisioning interface between control planes 922 and 932, communication interface 925 can provide control-plane-to-control plane communications. Control plane 932 can perform a gatekeeper operation for configuration of shared resources. For example, via communication interface 925, ACC control plane 922 can communicate with control plane 932 to perform one or more of: determine hardware capabilities, access the data plane configuration, reserve hardware resources and configuration, communications between ACC and MCC through interrupts or polling, subscription to receive hardware events, perform indirect hardware registers read write for debuggability, flash and physical layer interface (PHY) configuration, or perform system provisioning for different deployments of network interface device such as: storage node, tenant hosting node, microservices backend, compute node, or others.

Communication interface 925 can be utilized by a negotiation protocol and configuration protocol running between ACC control plane 922 and MCC control plane 932. Communication interface 925 can include a general purpose mailbox for different operations performed by packet processing circuitry 940. Examples of operations of packet processing circuitry 940 include issuance of non-volatile memory express (NVMe) reads or writes, issuance of Non-volatile Memory Express over Fabrics (NVMe-oF™) reads or writes, lookaside crypto Engine (LCE) (e.g., compression or decompression), Address Translation Engine (ATE) (e.g., input output memory management unit (IOMMU) to provide virtual-to-physical address translation), encryption or decryption, configuration as a storage node, configuration as a tenant hosting node, configuration as a compute node, provide multiple different types of services between different Peripheral Component Interconnect Express (PCIe) end points, or others.

Communication interface 925 can include one or more mailboxes accessible as registers or memory addresses. For communications from control plane 922 to control plane 932, communications can be written to the one or more mailboxes by control plane drivers 924. For communications from control plane 932 to control plane 922, communications can be written to the one or more mailboxes. Communications written to mailboxes can include descriptors which include message opcode, message error, message parameters, and other information. Communications written to mailboxes can include defined format messages that convey data.

Communication interface 925 can provide communications based on writes or reads to particular memory addresses (e.g., dynamic random access memory (DRAM)), registers, other mailbox that is written-to and read-from to pass commands and data. To provide for secure communications between control planes 922 and 932, registers and memory addresses (and memory address translations) for communications can be available only to be written to or read from by control planes 922 and 932 or cloud service provider (CSP) software executing on ACC 920 and device vendor software, embedded software, or firmware executing on MCC 930. Communication interface 925 can support communications between multiple different compute complexes such as from host 900 to MCC 930, host 900 to ACC 920, MCC 930 to ACC 920, baseboard management controller (BMC) to MCC 930, BMC to ACC 920, or BMC to host 900.

Packet processing circuitry 940 can be implemented using one or more of: application specific integrated circuit (ASIC), field programmable gate array (FPGA), processors executing software, or other circuitry. Control plane 922 and/or 932 can configure packet processing pipeline circuitry 940 or other processors to perform operations related to NVMe, NVMe-oF reads or writes, lookaside crypto Engine (LCE), Address Translation Engine (ATE), local area network (LAN), compression/decompression, encryption/decryption, or other accelerated operations.

Various message formats can be used to configure ACC 920 or MCC 930. In some examples, a P4 program can be compiled and provided to MCC 930 to configure packet processing circuitry 940. The following is a JSON configuration file that can be transmitted from ACC 920 to MCC 930 to get capabilities of packet processing circuitry 940 and/or other circuitry in packet processing device 910. More particularly, the file can be used to specify a number of transmit queues, number of receive queues, number of supported traffic classes (TC), number of available interrupt vectors, number of available virtual ports and the types of the ports, size of allocated memory, supported parser profiles, exact match table profiles, packet mirroring profiles, among others.

FIG. 9B depicts an example network interface device system. Various examples of packet processing device or network interface device 910 can utilize components of the system of FIG. 9B. In some examples, packet processing device or network interface device can refer to one or more of: a network interface controller (NIC), a remote direct memory access (RDMA)-enabled NIC, SmartNIC, router, switch, forwarding element, infrastructure processing unit (IPU), or data processing unit (DPU). Network subsystem 960 can be communicatively coupled to compute complex 980. Device interface 962 can provide an interface to communicate with a host. Various examples of device interface 962 can utilize protocols based on Peripheral Component Interconnect Express (PCIe), Compute Express Link (CXL), or others as well as virtual device interface such as virtual device interfaces.

Interfaces 964 can initiate and terminate at least offloaded remote direct memory access (RDMA) operations, Non-volatile memory express (NVMe) reads or writes operations, and LAN operations. Packet processing pipeline 966 can perform packet processing (e.g., packet header and/or packet payload) based on a configuration and support quality of service (QoS) and telemetry reporting. Inline processor 968 can perform offloaded encryption or decryption of packet communications (e.g., Internet Protocol Security (IPSec) or others). Traffic shaper 970 can schedule transmission of communications. Network interface 972 can provide an interface at least to an Ethernet network by media access control (MAC) and serializer/de-serializer (Serdes) operations.

Cores 982 can be configured to perform infrastructure operations such as storage initiator, Transport Layer Security (TLS) proxy, virtual switch (e.g., vSwitch), or other operations. Memory 984 can store applications and data to be performed or processed. Offload circuitry 986 can perform at least cryptographic and compression operations for host or use by compute complex 980. Offload circuitry 986 can include one or more graphics processing units (GPUs) that can access memory 984. Management complex 988 can perform secure boot, life cycle management and management of network subsystem 960 and/or compute complex 980.

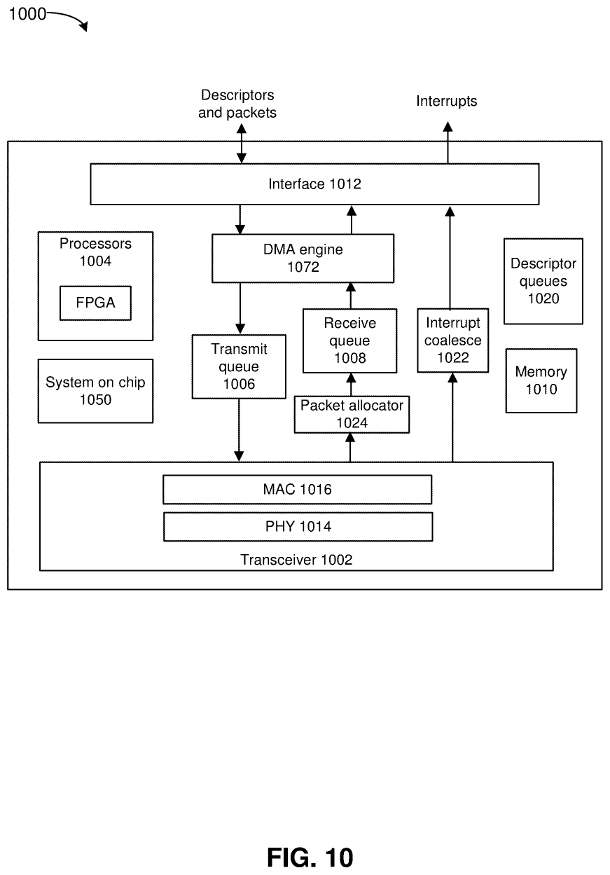

FIG. 10 depicts an example network interface device or packet processing device. In some examples, packet processing device 1000 can be implemented as a network interface controller, network interface card, a host fabric interface (HFI), or host bus adapter (HBA), and such examples can be interchangeable. Packet processing device 1000 can be coupled to one or more servers using a bus, PCIe, CXL, or Double Data Rate (DDR). Packet processing device 1000 may be embodied as part of a system-on-a-chip (SoC) that includes one or more processors, or included on a multichip package that also contains one or more processors.

Some examples of packet processing device 1000 are part of an Infrastructure Processing Unit (IPU) or data processing unit (DPU) or utilized by an IPU or DPU. An xPU can refer at least to an IPU, DPU, GPU, GPGPU, or other processing units (e.g., accelerator devices). An IPU or DPU can include a network interface with one or more programmable or fixed function processors to perform offload of operations that could have been performed by a CPU. The IPU or DPU can include one or more memory devices. In some examples, the IPU or DPU can perform virtual switch operations, manage storage transactions (e.g., compression, cryptography, virtualization), and manage operations performed on other IPUs, DPUs, servers, or devices.

Network interface 1000 can include transceiver 1002, processors 1004, transmit queue 1006, receive queue 1008, memory 1010, and bus interface 1012, and DMA engine 1052. Transceiver 1002 can be capable of receiving and transmitting packets in conformance with the applicable protocols such as Ethernet as described in IEEE 802.3, although other protocols may be used. Transceiver 1002 can receive and transmit packets from and to a network via a network medium (not depicted). Transceiver 1002 can include PHY circuitry 1014 and media access control (MAC) circuitry 1016. PHY circuitry 1014 can include encoding and decoding circuitry (not shown) to encode and decode data packets according to applicable physical layer specifications or standards. MAC circuitry 1016 can be configured to assemble data to be transmitted into packets, that include destination and source addresses along with network control information and error detection hash values.

Processors 1004 can be any a combination of a: processor, core, graphics processing unit (GPU), field programmable gate array (FPGA), application specific integrated circuit (ASIC), or other programmable hardware device that allow programming of network interface 1000. For example, a “smart network interface” can provide packet processing capabilities in the network interface using processors 1004.

Processors 1004 can include one or more packet processing pipeline that can be configured to perform match-action on received packets to identify packet processing rules and next hops using information stored in a ternary content-addressable memory (TCAM) tables or exact match tables in some embodiments. For example, match-action tables or circuitry can be used whereby a hash of a portion of a packet is used as an index to find an entry. Packet processing pipelines can perform one or more of: packet parsing (parser), exact match-action (e.g., small exact match (SEM) engine or a large exact match (LEM)), wildcard match-action (WCM), longest prefix match block (LPM), a hash block (e.g., receive side scaling (RSS)), a packet modifier (modifier), or traffic manager (e.g., transmit rate metering or shaping). For example, packet processing pipelines can implement access control list (ACL) or packet drops due to queue overflow.

Configuration of operation of processors 1004, including its data plane, can be programmed based on one or more of: Protocol-independent Packet Processors (P4), Software for Open Networking in the Cloud (SONiC), Broadcom® Network Programming Language (NPL), NVIDIA® CUDA®, NVIDIA® DOCA™, Infrastructure Programmer Development Kit (IPDK), among others.

Packet allocator 1024 can provide distribution of received packets for processing by multiple CPUs or cores using timeslot allocation described herein or RSS. When packet allocator 1024 uses RSS, packet allocator 1024 can calculate a hash or make another determination based on contents of a received packet to determine which CPU or core is to process a packet.

Interrupt coalesce 1022 can perform interrupt moderation whereby network interface interrupt coalesce 1022 waits for multiple packets to arrive, or for a time-out to expire, before generating an interrupt to host system to process received packet(s). Receive Segment Coalescing (RSC) can be performed by network interface 1000 whereby portions of incoming packets are combined into segments of a packet. Network interface 1000 provides this coalesced packet to an application.

Direct memory access (DMA) engine 1052 can copy a packet header, packet payload, and/or descriptor directly from host memory to the network interface or vice versa, instead of copying the packet to an intermediate buffer at the host and then using another copy operation from the intermediate buffer to the destination buffer.

Memory 1010 can be any type of volatile or non-volatile memory device and can store any queue or instructions used to program network interface 1000. Transmit queue 1006 can include data or references to data for transmission by network interface. Receive queue 1008 can include data or references to data that was received by network interface from a network. Descriptor queues 1020 can include descriptors that reference data or packets in transmit queue 1006 or receive queue 1008. Bus interface 1012 can provide an interface with host device (not depicted). For example, bus interface 1012 can be compatible with PCI, PCI Express, PCI-x, Serial ATA, and/or USB compatible interface (although other interconnection standards may be used).

FIG. 11 depicts a system. In some examples, interface 1112 or 1114 can utilize pacing circuitry, as described herein. In some examples, circuitry (e.g., processor 1110, interface 1112, interface 1114, and/or network interface 1150) can utilize technologies to adjust packet processing resources based on bursty traffic, as described herein. System 1100 includes processor 1110, which provides processing, operation management, and execution of instructions for system 1100. Processor 1110 can include any type of microprocessor, central processing unit (CPU), graphics processing unit (GPU), XPU, processing core, or other processing hardware to provide processing for system 1100, or a combination of processors. An XPU can include one or more of: a CPU, a graphics processing unit (GPU), general purpose GPU (GPGPU), and/or other processing units (e.g., accelerators or programmable or fixed function FPGAs). Processor 1110 controls the overall operation of system 1100, and can be or include, one or more programmable general-purpose or special-purpose microprocessors, digital signal processors (DSPs), programmable controllers, application specific integrated circuits (ASICs), programmable logic devices (PLDs), or the like, or a combination of such devices.

In one example, system 1100 includes interface 1112 coupled to processor 1110, which can represent a higher speed interface or a high throughput interface for system components that needs higher bandwidth connections, such as memory subsystem 1120 or graphics interface components 1140, or accelerators 1142. Interface 1112 represents an interface circuit, which can be a standalone component or integrated onto a processor die. Where present, graphics interface 1140 interfaces to graphics components for providing a visual display to a user of system 1100. In one example, graphics interface 1140 can drive a display that provides an output to a user. In one example, the display can include a touchscreen display. In one example, graphics interface 1140 generates a display based on data stored in memory 1130 or based on operations executed by processor 1110 or both. In one example, graphics interface 1140 generates a display based on data stored in memory 1130 or based on operations executed by processor 1110 or both.

Accelerators 1142 can be a programmable or fixed function offload engine that can be accessed or used by a processor 1110. For example, an accelerator among accelerators 1142 can provide data compression (DC) capability, cryptography services such as public key encryption (PKE), cipher, hash/authentication capabilities, decryption, or other capabilities or services. In some cases, accelerators 1142 can be integrated into a CPU socket (e.g., a connector to a motherboard or circuit board that includes a CPU and provides an electrical interface with the CPU). For example, accelerators 1142 can include a single or multi-core processor, graphics processing unit, logical execution unit single or multi-level cache, functional units usable to independently execute programs or threads, application specific integrated circuits (ASICs), neural network processors (NNPs), programmable control logic, and programmable processing elements such as field programmable gate arrays (FPGAs). Accelerators 1142 can provide multiple neural networks, CPUs, processor cores, general purpose graphics processing units, or graphics processing units can be made available for use by artificial intelligence (AI) or machine learning (ML) models. For example, the AI model can use or include any or a combination of: a reinforcement learning scheme, Q-learning scheme, deep-Q learning, or Asynchronous Advantage Actor-Critic (A3C), combinatorial neural network, recurrent combinatorial neural network, or other AI or ML model. Multiple neural networks, processor cores, or graphics processing units can be made available for use by AI or ML models to perform learning and/or inference operations.

Memory subsystem 1120 represents the main memory of system 1100 and provides storage for code to be executed by processor 1110, or data values to be used in executing a routine. Memory subsystem 1120 can include one or more memory devices 1130 such as read-only memory (ROM), flash memory, one or more varieties of random access memory (RAM) such as DRAM, or other memory devices, or a combination of such devices. Memory 1130 stores and hosts, among other things, operating system (OS) 1132 to provide a software platform for execution of instructions in system 1100. Additionally, applications 1134 can execute on the software platform of OS 1132 from memory 1130. Applications 1134 represent programs that have their own operational logic to perform execution of one or more functions. Processes 1136 represent agents or routines that provide auxiliary functions to OS 1132 or one or more applications 1134 or a combination. OS 1132, applications 1134, and processes 1136 provide software logic to provide functions for system 1100. In one example, memory subsystem 1120 includes memory controller 1122, which is a memory controller to generate and issue commands to memory 1130. It will be understood that memory controller 1122 could be a physical part of processor 1110 or a physical part of interface 1112. For example, memory controller 1122 can be an integrated memory controller, integrated onto a circuit with processor 1110.

Applications 1134 and/or processes 1136 can refer instead or additionally to a virtual machine (VM), container, microservice, processor, or other software. Various examples described herein can perform an application composed of microservices, where a microservice runs in its own process and communicates using protocols (e.g., application program interface (API), a Hypertext Transfer Protocol (HTTP) resource API, message service, remote procedure calls (RPC), or Google RPC (gRPC)). Microservices can communicate with one another using a service mesh and be executed in one or more data centers or edge networks. Microservices can be independently deployed using centralized management of these services. The management system may be written in different programming languages and use different data storage technologies. A microservice can be characterized by one or more of: polyglot programming (e.g., code written in multiple languages to capture additional functionality and efficiency not available in a single language), or lightweight container or virtual machine deployment, and decentralized continuous microservice delivery.

In some examples, OS 1132 can be Linux®, Windows® Server or personal computer, FreeBSD®, Android®, MacOS®, iOS®, VMware vSphere, openSUSE, RHEL, CentOS, Debian, Ubuntu, or any other operating system. The OS and driver can execute on a processor sold or designed by Intel®, ARM®, AMD®, Qualcomm®, IBM®, Nvidia®, Broadcom®, Texas Instruments®, among others.

While not specifically illustrated, it will be understood that system 1100 can include one or more buses or bus systems between devices, such as a memory bus, a graphics bus, interface buses, or others. Buses or other signal lines can communicatively or electrically couple components together, or both communicatively and electrically couple the components. Buses can include physical communication lines, point-to-point connections, bridges, adapters, controllers, or other circuitry or a combination. Buses can include, for example, one or more of a system bus, a Peripheral Component Interconnect (PCI) bus, a Hyper Transport or industry standard architecture (ISA) bus, a small computer system interface (SCSI) bus, a universal serial bus (USB), or an Institute of Electrical and Electronics Engineers (IEEE) standard 1394 bus (Firewire).

In one example, system 1100 includes interface 1114, which can be coupled to interface 1112. In one example, interface 1114 represents an interface circuit, which can include standalone components and integrated circuitry. In one example, multiple user interface components or peripheral components, or both, couple to interface 1114. Network interface 1150 provides system 1100 the ability to communicate with remote devices (e.g., servers or other computing devices) over one or more networks. Network interface 1150 can include an Ethernet adapter, wireless interconnection components, cellular network interconnection components, USB (universal serial bus), or other wired or wireless standards-based or proprietary interfaces. Network interface 1150 can transmit data to a device that is in the same data center or rack or a remote device, which can include sending data stored in memory. Network interface 1150 can receive data from a remote device, which can include storing received data into memory. In some examples, packet processing device or network interface device 1150 can refer to one or more of: a network interface controller (NIC), a remote direct memory access (RDMA)-enabled NIC, SmartNIC, router, switch, forwarding element, infrastructure processing unit (IPU), or data processing unit (DPU). An example IPU or DPU is described with respect to FIG. 10.

In one example, system 1100 includes one or more input/output (I/O) interface(s) 1160. I/O interface 1160 can include one or more interface components through which a user interacts with system 1100. Peripheral interface 1170 can include any hardware interface not specifically mentioned above. Peripherals refer generally to devices that connect dependently to system 1100.

In one example, system 1100 includes storage subsystem 1180 to store data in a nonvolatile manner. In one example, in certain system implementations, at least certain components of storage 1180 can overlap with components of memory subsystem 1120. Storage subsystem 1180 includes storage device(s) 1184, which can be or include any conventional medium for storing large amounts of data in a nonvolatile manner, such as one or more magnetic, solid state, or optical based disks, or a combination. Storage 1184 holds code or instructions and data 1186 in a persistent state (e.g., the value is retained despite interruption of power to system 1100). Storage 1184 can be generically considered to be a “memory,” although memory 1130 is typically the executing or operating memory to provide instructions to processor 1110. Whereas storage 1184 is nonvolatile, memory 1130 can include volatile memory (e.g., the value or state of the data is indeterminate if power is interrupted to system 1100). In one example, storage subsystem 1180 includes controller 1182 to interface with storage 1184. In one example controller 1182 is a physical part of interface 1114 or processor 1110 or can include circuits or logic in both processor 1110 and interface 1114.

A volatile memory is memory whose state (and therefore the data stored in it) is indeterminate if power is interrupted to the device. A non-volatile memory (NVM) device is a memory whose state is determinate even if power is interrupted to the device.

In an example, system 1100 can be implemented using interconnected compute sleds of processors, memories, storages, network interfaces, and other components. High speed interconnects can be used such as: Ethernet (IEEE 802.3), remote direct memory access (RDMA), InfiniBand, Internet Wide Area RDMA Protocol (iWARP), Transmission Control Protocol (TCP), User Datagram Protocol (UDP), quick UDP Internet Connections (QUIC), RDMA over Converged Ethernet (RoCE), Peripheral Component Interconnect express (PCIe), Intel QuickPath Interconnect (QPI), Intel Ultra Path Interconnect (UPI), Intel On-Chip System Fabric (IOSF), Omni-Path, Compute Express Link (CXL), HyperTransport, high-speed fabric, NVLink, Advanced Microcontroller Bus Architecture (AMBA) interconnect, OpenCAPI, Gen-Z, Infinity Fabric (IF), Cache Coherent Interconnect for Accelerators (CCIX), 3GPP Long Term Evolution (LTE) (4G), 3GPP 5G, and variations thereof. Data can be copied or stored to virtualized storage nodes or accessed using a protocol such as NVMe over Fabrics (NVMe-oF) or NVMe (e.g., a non-volatile memory express (NVMe) device can operate in a manner consistent with the Non-Volatile Memory Express (NVMe) Specification, revision 1.3c, published on May 24, 2018 (“NVMe specification”) or derivatives or variations thereof).

Communications between devices can take place using a network that provides die-to-die communications; chip-to-chip communications; circuit board-to-circuit board communications; and/or package-to-package communications.

In an example, system 800 can be implemented using interconnected compute platforms of processors, memories, storages, network interfaces, and other components. High speed interconnects can be used such as PCIe, Ethernet, or optical interconnects (or a combination thereof).

Examples herein may be implemented in various types of computing and networking equipment, such as switches, routers, racks, and blade servers such as those employed in a data center and/or server farm environment. The servers used in data centers and server farms comprise arrayed server configurations such as rack-based servers or blade servers. These servers are interconnected in communication via various network provisions, such as partitioning sets of servers into Local Area Networks (LANs) with appropriate switching and routing facilities between the LANs to form a private Intranet. For example, cloud hosting facilities may typically employ large data centers with a multitude of servers. A blade comprises a separate computing platform that is configured to perform server-type functions, that is, a “server on a card.” Accordingly, a blade includes components common to conventional servers, including a main printed circuit board (main board) providing internal wiring (e.g., buses) for coupling appropriate integrated circuits (ICs) and other components mounted to the board.

Various examples may be implemented using hardware elements, software elements, or a combination of both. In some examples, hardware elements may include devices, components, processors, microprocessors, circuits, circuit elements (e.g., transistors, resistors, capacitors, inductors, and so forth), integrated circuits, ASICs, PLDs, DSPs, FPGAs, memory units, logic gates, registers, semiconductor device, chips, microchips, chip sets, and so forth. In some examples, software elements may include software components, programs, applications, computer programs, application programs, system programs, machine programs, operating system software, middleware, firmware, software modules, routines, subroutines, functions, methods, procedures, software interfaces, APIs, instruction sets, computing code, computer code, code segments, computer code segments, words, values, symbols, or any combination thereof. Determining whether an example is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation. A processor can be one or more combination of a hardware state machine, digital control logic, central processing unit, or any hardware, firmware and/or software elements.

Some examples may be implemented using or as an article of manufacture or at least one computer-readable medium. A computer-readable medium may include a non-transitory storage medium to store logic. In some examples, the non-transitory storage medium may include one or more types of computer-readable storage media capable of storing electronic data, including volatile memory or non-volatile memory, removable or non-removable memory, erasable or non-erasable memory, writeable or re-writeable memory, and so forth. In some examples, the logic may include various software elements, such as software components, programs, applications, computer programs, application programs, system programs, machine programs, operating system software, middleware, firmware, software modules, routines, subroutines, functions, methods, procedures, software interfaces, API, instruction sets, computing code, computer code, code segments, computer code segments, words, values, symbols, or any combination thereof.

According to some examples, a computer-readable medium may include a non-transitory storage medium to store or maintain instructions that when executed by a machine, computing device or system, cause the machine, computing device or system to perform methods and/or operations in accordance with the described examples. The instructions may include any suitable type of code, such as source code, compiled code, interpreted code, executable code, static code, dynamic code, and the like. The instructions may be implemented according to a predefined computer language, manner or syntax, for instructing a machine, computing device or system to perform a certain function. The instructions may be implemented using any suitable high-level, low-level, object-oriented, visual, compiled and/or interpreted programming language.

One or more aspects of at least one example may be implemented by representative instructions stored on at least one machine-readable medium which represents various logic within the processor, which when read by a machine, computing device or system causes the machine, computing device or system to fabricate logic to perform the techniques described herein. Such representations, known as “IP cores” may be stored on a tangible, machine readable medium and supplied to various customers or manufacturing facilities to load into the fabrication machines that actually make the logic or processor.

The appearances of the phrase “one example” or “an example” are not necessarily all referring to the same example or embodiment. Any aspect described herein can be combined with any other aspect or similar aspect described herein, regardless of whether the aspects are described with respect to the same figure or element. Division, omission, or inclusion of block functions depicted in the accompanying figures does not infer that the hardware components, circuits, software and/or elements for implementing these functions would necessarily be divided, omitted, or included in embodiments.

Some examples may be described using the expression “coupled” and “connected” along with their derivatives. These terms are not necessarily intended as synonyms for each other. For example, descriptions using the terms “connected” and/or “coupled” may indicate that two or more elements are in direct physical or electrical contact with each other. The term “coupled,” however, may also mean that two or more elements are not in direct contact with each other, but yet still co-operate or interact with each other.

The terms “first,” “second,” and the like, herein do not denote any order, quantity, or importance, but rather are used to distinguish one element from another. The terms “a” and “an” herein do not denote a limitation of quantity, but rather denote the presence of at least one of the referenced items. The term “asserted” used herein with reference to a signal denote a state of the signal, in which the signal is active, and which can be achieved by applying any logic level either logic 0 or logic 1 to the signal. The terms “follow” or “after” can refer to immediately following or following after some other event or events. Other sequences of operations may also be performed according to alternative embodiments. Furthermore, additional operations may be added or removed depending on the particular applications. Any combination of changes can be used and one of ordinary skill in the art with the benefit of this disclosure would understand the many variations, modifications, and alternative embodiments thereof.

Disjunctive language such as the phrase “at least one of X, Y, or Z,” unless specifically stated otherwise, is otherwise understood within the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present. Additionally, conjunctive language such as the phrase “at least one of X, Y, and Z,” unless specifically stated otherwise, should also be understood to mean X, Y, Z, or any combination thereof, including “X, Y, and/or Z.”

Illustrative examples of the devices, systems, and methods disclosed herein are provided below. An embodiment of the devices, systems, and methods may include any one or more, and any combination of, the examples described below.

Example 1 includes one or more examples, and includes an apparatus that includes a system within a package comprising: a communication fabric and circuitry to adjust a packet throughput rate associated with the communication fabric based at least in part on incoming receive rate across multiple input ports and fabric usage, wherein: the communication fabric is to communicatively couple devices in the package including one or more of: an accelerator, a processor, a memory, or a network interface device.

Example 2 includes one or more examples, wherein the circuitry is to adjust the packet throughput rate of the communication fabric by control of an ingress rate of packets into the communication fabric.

Example 3 includes one or more examples, wherein the communication fabric includes a physical interconnect, a bridge, Caching Agents, Home Agents, snoop filters, and queues.

Example 4 includes one or more examples, wherein the communication fabric comprises at least one ingress port, the at least one ingress port is to receive the packet from the circuitry, and the circuitry comprises at least one timing pacing circuitry per ingress port.

Example 5 includes one or more examples, wherein the circuitry comprises at least one queue to enqueue packets and delay dequeue packets until specified times.

Example 6 includes one or more examples, and includes circuitry to adjust utilization of a core based on detection of a burst in packet traffic.

Example 7 includes one or more examples, wherein the detection of a burst in packet traffic is based on detected repeated changes relative to a level of power and/or frequency of a core, accelerator, or network interface device that processes the packet traffic.

Example 8 includes one or more examples, wherein the adjust utilization of a core based on a burst in packet traffic comprises one or more of: add additional processor capacity to process packets, disable core frequency management, migrate data processing thread to another core, notify a network interface device to route a percentage of received network traffic to a different one or more receive queues, notify a data-plane application to forward a percentage of network traffic to a polling thread running on another core, or raise an alarm to identify a bursty network interface.

Example 9 includes one or more examples, wherein the package comprises the accelerator, the processor, a memory, and the network interface device.

Example 10 includes one or more examples, wherein based on a level of the communication fabric, the circuitry is to be disabled from performance of adjustment of packet throughput rate associated with the communication fabric.

Example 11 includes one or more examples, and includes a non-transitory computer-readable medium comprising instructions stored thereon, that if executed by one or more processors, cause the one or more processors to: enable timed pacing circuitry to adjust a packet throughput rate associated with a communication fabric based at least in part on incoming receive rate across multiple input ports and fabric usage, wherein: the communication fabric and the timed pacing circuitry are enclosed within a package and the communication fabric is to communicatively couple devices in the package including one or more of: an accelerator, a processor, a memory, or a network interface device.

Example 12 includes one or more examples, wherein to adjust the packet throughput rate of the communication fabric comprises control of an ingress rate of packets into the communication fabric.

Example 13 includes one or more examples, wherein the communication fabric includes a physical interconnect, a bridge, Caching Agents, Home Agents, snoop filters, and queues.

Example 14 includes one or more examples, wherein at least one packet comprises one or more of: a network packet, a Peripheral Component Interconnect Express (PCIe) Transaction Layer Packet (TLP) packet, or a cache line size data.

Example 15 includes one or more examples, and includes instructions stored thereon, that if executed by one or more processors, cause the one or more processors to: enable circuitry to adjust utilization of a core based on detection of a burst in packet traffic.

Example 16 includes one or more examples, wherein the detection of a burst in packet traffic is based on detected repeated changes relative to a level of power and/or frequency of a core, accelerator, or network interface device that processes the packet traffic.

Example 17 includes one or more examples, and includes a method that includes: for a communications fabric for devices within a package: adjusting a packet throughput rate associated with the communication fabric based at least in part on incoming receive rate across multiple input ports and fabric usage, wherein the communication fabric is to communicatively couple devices in the package including one or more of: an accelerator, a processor, a memory, or a network interface device.

Example 18 includes one or more examples, wherein the communication fabric includes a physical interconnect, a bridge, Caching Agents, Home Agents, snoop filter, and queues.

Example 19 includes one or more examples, wherein at least one packet comprises one or more of: an Ethernet packet, a Peripheral Component Interconnect Express (PCIe) Transaction Layer Packet (TLP) packet, or a cache line size data.

Example 20 includes one or more examples, and includes adjusting utilization of a core based on detection of a burst in packet traffic.

1. An apparatus comprising:
a system within a package comprising:
a communication fabric and
circuitry to adjust a packet throughput rate associated with the communication fabric based at least in part on incoming receive rate across multiple input ports and fabric usage, wherein:
the communication fabric is to communicatively couple devices in the package including one or more of: an accelerator, a processor, a memory, or a network interface device.

2. The apparatus of claim 1, wherein the circuitry is to adjust the packet throughput rate of the communication fabric by control of an ingress rate of packets into the communication fabric.

3. The apparatus of claim 1, wherein the communication fabric includes a physical interconnect, a bridge, Caching Agents, Home Agents, snoop filters, and queues.

4. The apparatus of claim 1, wherein
the communication fabric comprises at least one ingress port,
the at least one ingress port is to receive the packet from the circuitry, and
the circuitry comprises at least one timing pacing circuitry per ingress port.

5. The apparatus of claim 1, wherein the circuitry comprises at least one queue to enqueue packets and delay dequeue packets until specified times.

6. The apparatus of claim 1, comprising:
circuitry to adjust utilization of a core based on detection of a burst in packet traffic.

7. The apparatus of claim 6, wherein the detection of a burst in packet traffic is based on detected repeated changes relative to a level of power and/or frequency of a core, accelerator, or network interface device that processes the packet traffic.

8. The apparatus of claim 6, wherein the adjust utilization of a core based on a burst in packet traffic comprises one or more of: add additional processor capacity to process packets, disable core frequency management, migrate data processing thread to another core, notify a network interface device to route a percentage of received network traffic to a different one or more receive queues, notify a data-plane application to forward a percentage of network traffic to a polling thread running on another core, or raise an alarm to identify a bursty network interface.

9. The apparatus of claim 6, wherein the package comprises the accelerator, the processor, a memory, and the network interface device.

10. The apparatus of claim 1, wherein based on a level of the communication fabric, the circuitry is to be disabled from performance of adjustment of packet throughput rate associated with the communication fabric.

11. A non-transitory computer-readable medium comprising instructions stored thereon, that if executed by one or more processors, cause the one or more processors to:
enable timed pacing circuitry to adjust a packet throughput rate associated with a communication fabric based at least in part on incoming receive rate across multiple input ports and fabric usage, wherein:
the communication fabric and the timed pacing circuitry are enclosed within a package and
the communication fabric is to communicatively couple devices in the package including one or more of: an accelerator, a processor, a memory, or a network interface device.

12. The non-transitory computer-readable medium of claim 11, wherein to adjust the packet throughput rate of the communication fabric comprises control of an ingress rate of packets into the communication fabric.

13. The non-transitory computer-readable medium of claim 11, wherein the communication fabric includes a physical interconnect, a bridge, Caching Agents, Home Agents, snoop filters, and queues.

14. The non-transitory computer-readable medium of claim 11, wherein at least one packet comprises one or more of: a network packet, a Peripheral Component Interconnect Express (PCIe) Transaction Layer Packet (TLP) packet, or a cache line size data.

15. The non-transitory computer-readable medium of claim 11, comprising instructions stored thereon, that if executed by one or more processors, cause the one or more processors to:
enable circuitry to adjust utilization of a core based on detection of a burst in packet traffic.

16. The non-transitory computer-readable medium of claim 15, wherein the detection of a burst in packet traffic is based on detected repeated changes relative to a level of power and/or frequency of a core, accelerator, or network interface device that processes the packet traffic.

17. A method comprising:
for a communications fabric for devices within a package:
adjusting a packet throughput rate associated with the communication fabric based at least in part on incoming receive rate across multiple input ports and fabric usage, wherein the communication fabric is to communicatively couple devices in the package including one or more of: an accelerator, a processor, a memory, or a network interface device.

18. The method of claim 17, wherein the communication fabric includes a physical interconnect, a bridge, Caching Agents, Home Agents, snoop filter, and queues.

19. The method of claim 17, wherein at least one packet comprises one or more of: an Ethernet packet, a Peripheral Component Interconnect Express (PCIe) Transaction Layer Packet (TLP) packet, or a cache line size data.

20. The method of claim 17, comprising:
adjusting utilization of a core based on detection of a burst in packet traffic.
